(19) United States
(12) Patent Application Publication
(10) Pub. No.: US 2012/0166556 A1
(43) Pub. Date: Jun. 28, 2012

(54) METHOD, DEVICE AND SYSTEM FOR REAL-TIME PUBLISH SUBSCRIBE DISCOVERY BASED ON DISTRIBUTED HASH TABLE

(75) Inventors: Jae Hyuk KIM, Seoul (KR); Soo Hyung Lee, Daejeon (KR); Hyung Kook Jun, Seoul (KR); Kyeong Tae Kim, Chuncheon (KR); Yong Yeon Kim, Daejeon (KR); Won Tae Kim, Asan (KR); Seung Min Park, Daejeon (KR)

(73) Assignee: Electronics and Telecommunications Research Institute, Daejeon (KR)

(21) Appl. No.: 13/292,775

(22) Filed: Nov. 9, 2011

(30) Foreign Application Priority Data
Dec. 23, 2010 (KR) 10-2010-0133176

(51) Int. Cl. G06F 15/16

(52) U.S. Cl. 709/206

(57) ABSTRACT

A method, a device, and a system for real-time publish subscribe (RTPS) discovery based on a distributed hash table (DHT) are provided. The method for RTPS discovery based on a DHT includes: registering, by a participant peer of participants, the participants in a distributed hash table (DHT) of an overlay network; obtaining location information on relative participants to be discovered from the DHT; sharing information on entities of the relative participants by exchanging a discovery message with the participant peer based on the location information on the obtained relative participants; and performing handshaking between the entities of the participants and the entities of the relative participants. Therefore, the exemplary embodiments of the present invention can rapidly and efficiently perform the discover of the participants based on the DHT.

### CROSS-REFERENCE TO RELATED APPLICATIONS

This application claims the benefit of priority of Korean Patent Application No. 10-2010-0133176 filed on Dec. 23, 2010, all of which are incorporated by reference in their entirety herein.

### BACKGROUND OF THE INVENTION

1. Field of the Invention

The present invention relates to a method, a device, and a system for real-time publish subscribe (RTPS) discovery based on a distributed hash table (DHT), and more particularly, to a technology of improving discovery efficiency at a cyber-physical system (CPS) or data distribution service (DDS) middleware based on, for example, a chord protocol, or the like, that searches related contents through a DHT of an overlay network.

2. Related Art

Generally, a cyber-physical system (CPS) platform for a high-reliable autonomous control is a platform that imparts high reliability to an application system operated under a physical environment that is hard to expect such as temperature, weather, topography, or the like. The CPS is provided to efficiently develop and verify intelligent distributed systems requiring high reliability and control an operation in real time.

CPS middleware, which is middleware that provides a data exchange function between devices in the CPS platform, may provide differential QoS for distributed CPS nodes while supporting a real-time data distribution function based on publish/subscribe. The CPS middleware may be provided based on a data distribution service (DDS) middleware technology that is established as an international standard by an object management group (OMG).

The CPS middleware may be largely divided into a data-centric publish-subscribe (DCPS) layer and a layer using a real-time publish subscribe (RTPS) protocol.

The DCPS layer, which is a middleware interface having specifications of publish/subscribe for distributed environment, may provide a standardized interface for a data-centric publish-subscribe programming model for the distributed environment. The layer using the RTPS protocol, which is a layer in which real data are published and subscribed, may determine domain formation and a type of data to be used and provide a function of dynamically searching participants at a remote place, that is, a discovery function. The DCPS layer may set QoS. In this case, reliable or unreliable data communication may be performed according to the set QoS.

Meanwhile, in order to search entities participating in the domain that is a concept of a set of application programs performing communication in the RTPS protocol, that is, participants, a search for the participants, that is, the participant discovery and a terminal entity search for transmitting and receiving entities existing in the participants, that is, end point discovery are performed.

However, since the participant discovery process in the existing RTPS protocol periodically transmits data using a multi-casting mechanism, there are problems in that time is delayed during the search process and a considerable load may be caused even in a network.

### SUMMARY OF THE INVENTION

The present invention provides a method, a device, and a system for real-time publish subscribe discovery based on a distributed hash table (DHT) capable of rapidly and efficiently performing a discovery for participants based on the DHT of an overlay network.

In an aspect, a method for RTPS discovery based on a DHT is provided. According to an exemplary embodiment of the present invention, there is provided a method for real-time publish subscribe (RTPS) discovery based on a DHT, including: registering, by a participant peer of participants, the participants in a distributed hash table (DHT) of an overlay network; obtaining location information on relative participants to be discovered from the DHT; sharing information on entities of the relative participants by exchanging a discovery message with the relative participant peer based on the location information on the obtained relative participants; and performing handshaking between the entities of the participants and the entities of the relative participants.

The registering of the participants may include registering topic data of the participants, identification information on the participants having the topic data, the location information on the participants in the DHT.

The obtaining of the location information on the relative participants may include: requesting information regarding the topic data to be discovered to the DHT; receiving the information regarding the requested topic data from the DHT; and acquiring the location information on the relative participants having the requested topic data from the information associated with the received topic data.

The sharing of the information on the entities of the relative participants may include: transmitting a message including attribute information on the entities of the participants to the relative participants by the relative participant peer using the location information on the obtained relative participants; and receiving a message including the attribute information on the entities of the relative participants from the relative participants.

The method for real-time publish subscribe (RTPS) discovery based on a DHT may further include checking whether there are the entities of the relative participants through a liveliness protocol.

The method for real-time publish subscribe (RTPS) discovery based on a DHT may further include sharing QoS between the entities of the participants and the entities of the relative participants.

In another aspect, a device for RTPS discovery based on a DHT is provided. There is provided a device for RTPS discovery based on a DHT, including: entities of participants included in participants and performing handshaking with entities of relative participants; and a participant peer registering the participants in the DHT of an overlay network, obtaining location information on the relative participants to be discovered from the DHT, and sharing information on the entities of the relative participants by exchanging a discovery message with the relative participant peer based on the location information on the obtained relative participants.

The participant peer may register topic data of the participants, identification information on the participants having the topic data, the location information on the participants in the DHT. The participant peer may request information regarding the topic data to be discovered to the DHT, receive the information regarding the requested topic data from the DHT, and acquire the location information on the relative participants having the requested topic data from the information associated with the received topic data.

The participant peer may transmit a message including attribute information on the entities of the participants to the relative participants by the relative participant peer using the location information on the obtained relative participants and receive a message including the attribute information on the entities of the relative participants from the relative participants. The participant peer may check whether there are the entities of the relative participants through a liveliness protocol.

In another aspect, a system for RTPS discovery based on a DHT is provided. There is provided a system for RTPS discovery based on a DHT, including: a second participant registered in the DHT of an overlay network; and a first participant registered in the DHT of an overlay network, obtaining location information on the second participant from the DHT, sharing information on an entity of the second participant by exchanging a discovery message with the second participant based on the location information, and performing handshaking with the entity of the second participant.

The first participants may register topic data of the first participants, identification information on the first participants having the topic data, the location information on the first participants in the DHT. The first participant may check whether there is the entity of the second participant through a liveliness protocol. The entities of the first participants may share QoS with the entities of the second participants.

The first participant may request information regarding the topic data to be discovered to the DHT, receive the information regarding the requested topic data from the DHT, and acquire the location information on the second participants having the requested topic data from the information associated with the received topic data.

### BRIEF DESCRIPTION OF THE DRAWINGS

FIG. 1 is a block diagram schematically showing a system operation environment for implementing a method for RTPS discovery based on a DHT according to an exemplary embodiment of the present invention.

FIG. 2 is a block diagram showing a module configuration of RTPS participants for implementing a method for RTPS discovery based on a DHT.

FIG. 3 is a flow chart for describing a flow of the method for RTPS discovery based on a DHT according to the exemplary embodiment of the present invention.

### DESCRIPTION OF EXEMPLARY EMBODIMENTS

Hereinafter, exemplary embodiments of the present invention will be described in detail with reference to the accompanying drawings so that those skilled in the art to which the present invention pertains can easily understand the technical matters of the present invention. Specific terms will be used in the exemplary embodiments of the present invention for clarity of the contents therein. However, the present invention is not limited to the specific terms selected therein but includes all technical synonyms operating in the same method so that each of the specific terms accomplish similar objects.

First, a general RTPS discover operation will be described. The RTPS discovery operation may largely include a process of searching relative participants, that is, a simple participant discovery protocol (SPDP) process for discovery and a simple entity discovery protocol (SEDP) process sharing QoS of entities included in each participant.

Describing in more detail the RTPS discovery operation, when the participants within a domain are generated by first operating a CPS middleware system, an RTPS protocol may automatically perform a discovery operation. When the participants are successfully generated, the SPDP operation searching the relative participants is performed. Meanwhile, a liveliness check that checks whether there is a dead path between the participants may be periodically performed.

When the discovery for the relative participants is successfully performed through the SPDP operation, handshaking may be performed between the entities in each participant using a heartbeat message that is a message defined in the RTPS protocol and an ACK/NACK message. As described above, when the handshaking is successfully performed between the entities, the SEDP process of sharing QoS between each entity may be performed.

As described above, in the CPS middleware system, after the participants are generated in the domain, the SPDP process is performed. In this case, the SPDP may be a protocol transmitting discovery data in multicast for a predetermined duration for the discovery of the relative participants. In this case, however, the data exchange may be frequently generated in a network in the domain due to the performance of the SPDP operation of several participants in one domain. Therefore, excessive load and time delay in the network may occur.

On the other hand, the method for RTPS discovery based on a DHT according to the exemplary embodiment of the present invention uses the DHT protocol prior to performing the SPDP operation to rapidly perform the discovery of the relative participants and efficiently operate the network without frequently transmitting and receiving the discovery data.

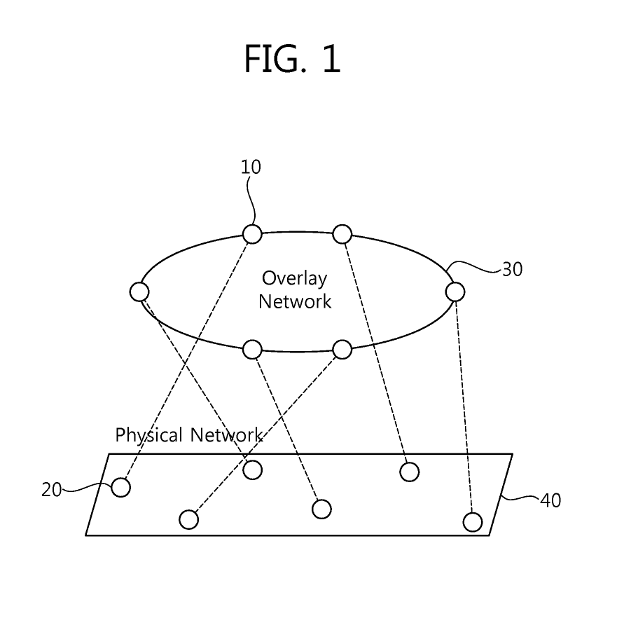

FIG. 1 is a block diagram schematically showing a system operation environment for implementing a method for RTPS discovery based on a DHT according to an exemplary embodiment of the present invention.

As shown in FIG. 1, a system for real-time publish subscribe (RTPS) discovery may be based on a structure that registers topic data included in participants 20 a physical network 40 in the DHT of a virtual overlay network 30 and facilitates a discovery of the participants 20 through the topic data for participants 10 existing in the overlay network.

That is, the system for RTPS discovery according to the exemplary embodiment of the present invention may be based on a data distributed service (DDS) structure based on the DHT of the overlay network 30. The structure can implement fast data search and extensibility since the topic data are stored in the participants 20 participating in the overlay network 30, that is, a hash table of a peer.

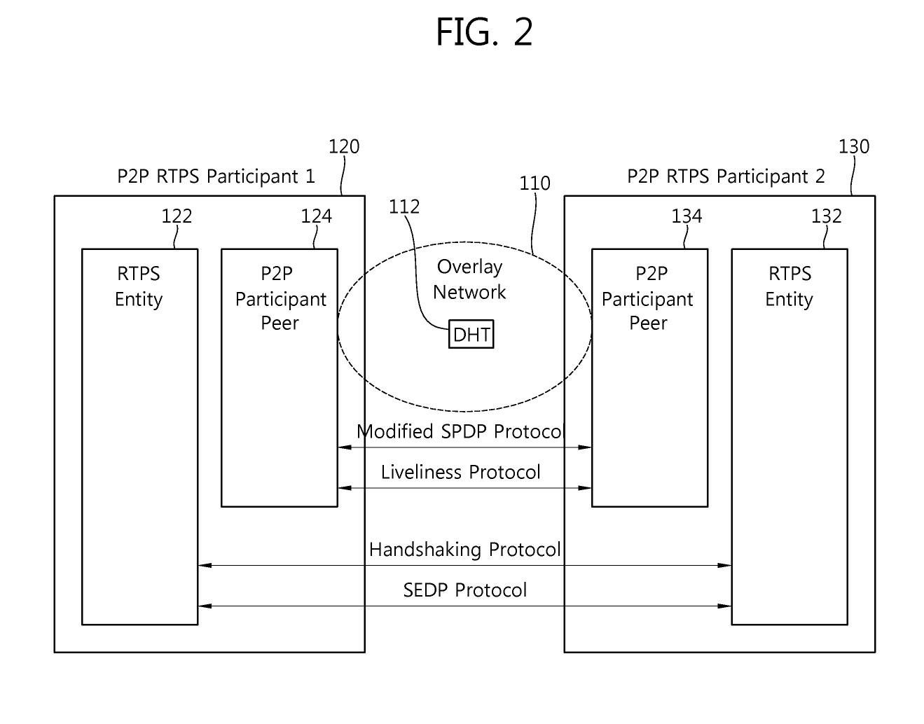

FIG. 2 is a block diagram showing a module configuration of the RTPS participants for implementing the method for RTPS discovery based on a DHT. FIG. 2 exemplarily shows peer to peer (P2P) participants capable of discovering the participants using the DHT and performing the SEDP operation between entities.

As shown in FIG. 2, each RTPS participant 120 and 130 may include P2P participant peers 124 and 134 and RTPS entities 122 and 132.

The P2P participant peers 124 and 134 may mean a peer module in which the P2P participant peers 124 and 134 are connected to each other in the overlay network 110. The P2P participant peers 124 and 134 uses the SPDP protocol based on a DHT 112 of the overlay network 110 to perform the SPDP operation therebetween. In the SPDP operation, the P2P participant peers 124 and 134 may be transmitted in unicast by discovering a location of the relative RTPS participants 120 and 130 based on the DHT 112 unlike the existing multicast mechanism.

For example, the P2P participant peers 124 and 134 may register the corresponding RTPS participants 120 and 130 in the DHT 112 of the overlay network 110 and obtain the location information on the relative RTPS participants 120 and 130 to be discovered from the DHT 112. RTPS entity information on the relative RTPS participants 120 and 130 may be obtained by exchanging the discovery message with the P2P participant peers 124 and 134 of the relative P2P participants 120 and 130 based on the location information on the obtained relative RTPS participants 120 and 130. The discovery message, which is a message that includes attribute values of the RTPS entities 122 and 132, may be a “PDPdiscoveredParticipant” message, or the like, at, for example, the SPDP.

The P2P participant peers 124 and 134 use a liveliness protocol to perform a liveliness operation, or the like, therebetween. For example, the P2P participant peers 124 and 134 may check whether there are the RTPS entities 122 and 132 of the relative RTPS participant 120 and 130 through the liveliness protocol.

The RTPS entities 122 and 132, which is a module that publishes and subscribes real topic data, may correspond to an endpoint at the RTPS discovery. For example, the RTPS entities 122 and 132 may include an RTPS writer, an RTPS reader, or the like. The RTPS entities 122 and 132 may perform handshaking, QoS sharing, or the like, according to a handshaking protocol and an SEDP protocol.

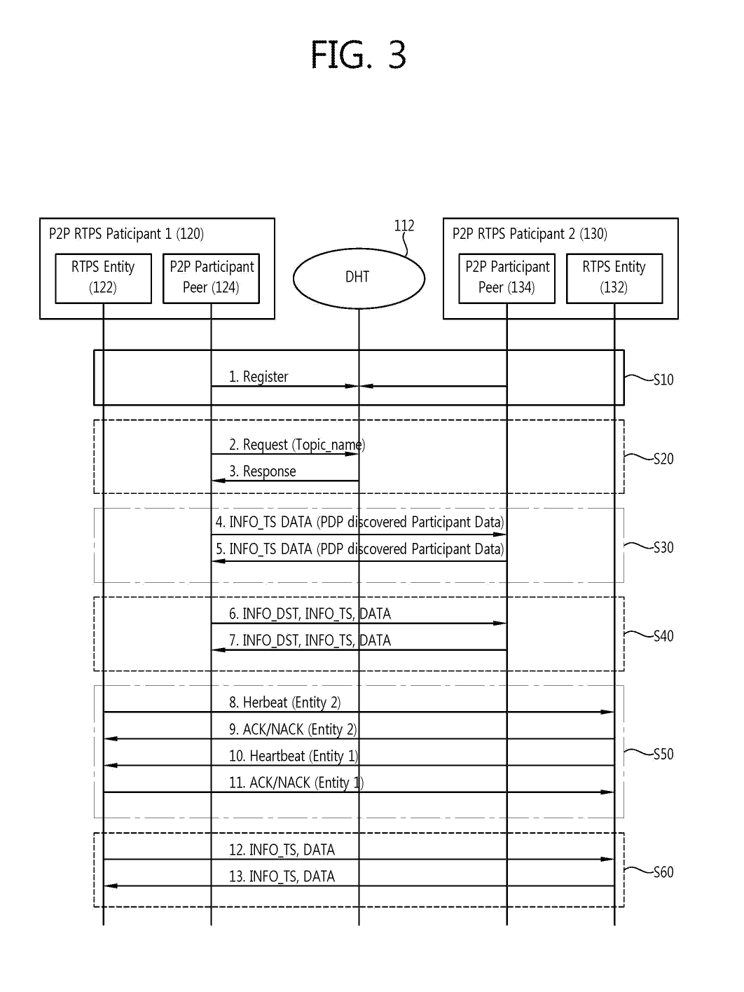

FIG. 3 is a flow chart for describing a flow of a method for RTPS discovery based on a DHT according to the exemplary embodiment of the present invention. Hereinafter, an example in which the first RTPS participant 120 discovers the second RTPS participant 130 based on the DHT 112 will be described in detail with reference to FIG. 3.

As shown in FIG. 3, the P2P participant peer 124 of the first RTPS participant 120 may first register the first RTPS participant 120 in the DHT 112 of the overlay network 110 (S10).

For example, the first RTPS participant 120 may register the topic data, the identification information, and the location information (for example, IP address, or the like) of the first RTPS participant 120 in the DHT 112. The topic data may include the sensor data (for example, temperature, humidity, weather, or the like), or the like, for the first RTPS participant 120. Similarly, the P2P participant peer 134 of the second RTPS participant 130 may first register the second RTPS participant 130 in the DHT 112 of the overlay network 110.

Then, the P2P participant peer 124 of the first RTPS participant 120 may obtain the location information on the relative participant to be discovered from the DHT 112, that is, the second RTPS participant 130 (S20).

For example, the P2P participant peer 124 of the first RTPS participant 120 may request the information regarding the topic data (that is, the topic data of the second RTPS participant) to be discovered to the DHT 112 and receive the response including the information regarding the topic data from the DHT 112. Further, the P2P participant peer 124 may obtain the location information on the second RTPS participant 130 having the topic data from the information associated with the received topic data.

Next, the P2P participant peer 124 of the first RTPS participant 120 exchanges the discovery message with the P2P participant peer 134 of the second RTPS participant 130 based on the location information on the obtained second RTPS participant 130 to share the RTPS entity information (S30). In this case, the used discovery message, which is a message that includes the attribute values of the RTPS entities, may be a “PDPdiscoveredParticipant” message, or the like, at, for example, the SPDP.

For example, the P2P participant peer 124 of the first RTPS participant 120 uses the location information on the obtained second RTPS participant 130 to transmit the message including the attribute information on the RTPS entity 122 of the first RTPS participant 120 to the P2P participant peer 134 of the second RTPS participant 130. In addition, the message including the attribute information on the RTPS entity 132 of the second RTPS participant 130 may be received from the P2P participant peer 134 of the second RTPS participant 130.

Then, the P2P participant peer 124 of the first RTPS participant 120 may check whether there is the RTPS entity 132 of the second RTPS participant 130 through the liveliness protocol (S40). For example, the P2P participant peer 124 of the first RTPS participant 120 exchanges the liveliness message with the P2P participant peer 134 of the second RTPS participant 130 to check whether there are the mutual RTPS entities 122 and 132.

Meanwhile, when the processes from S10 to S40 are successfully performed, the RTPS entity 122 of the first RTPS participant 120 may perform the handshaking with the RTPS entity 132 of the second RTPS participant 130. For example, the RTPS entity 122 of the first RTPS participant 120 may transmit the heartbeat message to the entity 132 of the second RTPS participant 130 and receive the ACK message or the NACK message as the response. In addition, when the heartbeat message is received from the entity 132 of the second RTPS participant 130, the ACK message or the NACK message may be transmitted as the response.

Next, the RTPS entity 122 of the first RTPS participant 120 may share the QoS with the RTPS entity 132 of the second RTPS participant 130. For example, the RTPS entity 122 of the first RTPS participant 120 may transmit the QoS message to the RTPS entity 132 of the second RTPS participant 130 and receive the QoS message transmitted from the RTPS entity 132 of the second RTPS participant 130.

As described above, unlike the related art performing the multi-cast type SPDP operation, the method for RTPS discovery based on a DHT according to the exemplary embodiments of the present invention may rapidly obtain the location information on the relative RTPS participants through the DHT of the overlay network at the P2P participant peer included in the RTPS participant and perform the SPDP operation through the unicast. Therefore, the exemplary embodiments of the present invention can rapidly and efficiently operate the network without frequently transmitting and receiving the data for the RTPS discovery in the domain

As set forth above, the exemplary embodiments of the present invention can rapidly obtain the location information on the relative RTPS participants through the DHT of the overlay network at the P2P participant peer included in the RTPS participants and perform the SPDP operation through the unicast. Therefore, unlike the related art performing the multicast-type SPDP operation, the exemplary embodiments of the present invention can rapidly and efficiently operate the network without frequently transmitting and receiving the RTPS discovery data within the domain.

While the present invention has been shown and described in connection with the embodiments, it will be apparent to those skilled in the art that modifications and variations can be made without departing from the spirit and scope of the invention as defined by the appended claims. Therefore, coming variations of the exemplary embodiments of the present invention will not depart from the technology of the present invention.

What is claimed is:

1. A method for real-time publish subscribe (RTPS) discovery based on a DHT, comprising:
registering, by a participant peer of participants, the participants in a distributed hash table (DHT) of an overlay network;
obtaining location information on relative participants to be discovered from the DHT;
sharing information on entities of the relative participants by exchanging a discovery message with the relative participant peer based on the location information on the obtained relative participants; and
performing handshaking between the entities of the participants and the entities of the relative participants.

2. The method of claim 1, wherein the registering of the participants includes registering topic data of the participants, identification information on the participants having the topic data, the location information on the participants in the DHT.

3. The method of claim 1, wherein the obtaining of the location information on the relative participants includes:
requesting information regarding the topic data to be discovered to the DHT;
receiving the information regarding the requested topic data from the DHT; and
acquiring the location information on the relative participants having the requested topic data from the information associated with the received topic data.

4. The method of claim 1, wherein the sharing of the information on the entities of the relative participants includes:
transmitting a message including attribute information on the entities of the participants to the relative participants by the relative participant peer using the location information on the obtained relative participants; and
receiving a message including the attribute information on the entities of the relative participants from the relative participants.

5. The method of claim 1, further comprising checking whether there are the entities of the relative participants through a liveliness protocol.

6. The method of claim 1, further comprising sharing QoS between the entities of the participants and the entities of the relative participants.

7. A device for RTPS discovery based on a DHT, comprising:
entities of participants included in participants and performing handshaking with entities of relative participants; and
a participant peer registering the participants in the DHT of an overlay network, obtaining location information on the relative participants to be discovered from the DHT, and sharing information on the entities of the relative participants by exchanging a discovery message with the relative participant peer based on the location information on the obtained relative participants.

8. The device of claim 7, wherein the participant peer registers topic data of the participants, identification information on the participants having the topic data, the location information on the participants in the DHT.

9. The device of claim 7, wherein the participant peer requests information regarding the topic data to be discovered to the DHT, receives the information regarding the requested topic data from the DHT, and acquires the location information on the relative participants having the requested topic data from the information associated with the received topic data.

10. The device of claim 7, wherein the participant peer transmits a message including attribute information on the entities of the participants to the relative participants by the relative participant peer using the location information on the obtained relative participants and receives a message including the attribute information on the entities of the relative participants from the relative participants.

11. The device of claim 7, wherein the participant peer checks whether there are the entities of the relative participants through a liveliness protocol.

12. The device of claim 7, wherein the entities of the participants share QoS with the entities of the relative participants.

13. A system for RTPS discovery based on a DHT, comprising:
a second participant registered in the DHT of an overlay network; and
a first participant registered in the DHT of an overlay network, obtaining location information on the second participant from the DHT, sharing information on an entity of the second participant by exchanging a discovery message with the second participant based on the location information, and performing handshaking with the entity of the second participant.

14. The system of claim 13, wherein the first participants register topic data of the first participants, identification information on the first participants having the topic data, the location information on the first participants in the DHT.

15. The system of claim 13, wherein the first participant requests information regarding the topic data to be discovered to the DHT, receives the information regarding the requested topic data from the DHT, and acquires the location information on the second relative participants having the requested topic data from the information associated with the received topic data.

16. The system of claim 13, wherein the first participant checks whether there is the entity of the second participant through a liveliness protocol

17. The system of claim 13, wherein the entities of the first participants share QoS with the entities of the second participants.
